(19) United States
(12) Patent Application Publication
(10) Pub. No.: US 2023/0411916 A1
(43) Pub. Date: Dec. 21, 2023

(54) Multifunctional hand held tool

(71) Applicant: HARTING Electric Stiftung & Co. KG, Espelkamp (DE)

(72) Inventors: Daniel WESSELER, Georgsmarienhütte (DE); Joachim KRÄMER, Kirchlengern (DE)

(73) Assignee: HARTING Electric Stiftung & Co. KG, Espelkamp (DE)

(21) Appl. No.: 18/035,459

(22) PCT Filed: Dec. 6, 2021
(86) PCT No.: PCT/DE2021/100974

§ 371 Date: May 4, 2023

(30) Foreign Application Priority Data
Dec. 14, 2020 (DE) 10 2020 133 326.9

(51) Int. Cl. H01R 43/042; H01R 43/045

(52) U.S. Cl. CPC H01R 43/0421; H01R 43/0428; H01R 43/045

(57) ABSTRACT

A crimping tool for crimping a contact sleeve onto an electrical conductor of a cable has at least a cable transport device, a cutting and stripping device, a crimping device and a printing device, which are disposed one following the other in this order in a direction on a cable feed-through of the crimping tool with an axis. The crimping tool is designed such that a cable end of the cable, which cable end is inserted via a cable inlet opening of the cable feed-through, is fed by the cable transport device in the direction to the cutting and stripping device, to the crimping device and to the printing device and subsequently is led out of the crimping tool via a cable outlet opening of the cable feed-through, which cable outlet opening is opposite the cable inlet opening.

### CROSS-REFERENCE TO RELATED APPLICATION

This application is a national stage application, filed under 35 U.S.C. § 371, of International Patent Application No. PCT/DE2021/100974, filed on 6 Dec. 2021, which claims the benefit of German Patent Application No. 10 2020 133 326.9, filed 14 Dec. 2020.

### TECHNICAL FIELD

The disclosure relates to a multifunctional hand-held tool for crimping contact sleeves onto electrical conductors of a cable. In particular, the disclosure relates to a method for crimping contact sleeves onto electrical conductors of a cable.

### BACKGROUND

Crimping tools are required for assembling cables with contact sleeves, especially for field processing, for example in control cabinet assembly.

DE 10 2010 019 124 A1 describes an electrically operated stripping and crimping hand-held tool, which is suitable for stripping cables and for crimping sleeves onto wires of stripped cables. In the known hand-held crimping tool, the stripping device and the crimping device are formed in a structural union, wherein similar motion sequences of the stripping device and the crimping device are required for their operation, according to which it should be possible to provide a hand-held tool having small dimensions by means of the structural union of the two devices.

The considerably complex motion sequences of the structurally united stripping device and crimping device required to carry out crimping as intended require a disadvantageously correspondingly complex mechanical system, wherein the hand-held crimping tool known from DE 10 2010 019 124 A1 is also disadvantageously limited to stripping cables and crimping ferrules onto their wires.

### SUMMARY

A problem addressed by the disclosure lies in providing a hand-held tool for crimping contact sleeves onto an electrical conductor of a cable, which combines multifunctional properties. In particular, the hand-held tool for crimping should be easy to handle. In particular, a problem addressed by the disclosure is that of providing a comprehensive method for crimping contact sleeves onto electrical conductors of a cable, which is easy to carry out and, in particular, suitable for field processing.

In particular, the disclosure relates to a crimping tool for crimping a contact sleeve onto an electrical conductor of a cable, wherein the crimping tool comprises at least a cable transport device, a trimming and stripping device, a crimping device, and a printing device, which are arranged in this order successively on a cable feed-through of the crimping tool with an axis. The above-mentioned devices are arranged in their order in a direction R corresponding to a cable feed-through direction for the cable through the cable feed-through of the crimping tool.

The crimping tool is designed here in such a way that a cable end of the cable inserted via a cable inlet opening of the cable feed-through is fed from the cable transport device in the cable feed-through direction to the trimming and stripping device, the crimping device, and the printing device, and is then led out of the crimping tool via a cable outlet opening of the cable feed-through opposite the cable inlet opening.

With the above devices combined and cooperating in one tool, it is possible to cut, trim and strip a cable with subsequent crimping of a contact sleeve onto the conductor of a stripped cable end, as well as to document the crimping performed, after which a multifunctional tool having a variety of functions is provided.

In this context, the crimping tool is particularly easily and intuitively handled after a cable end has been processed by inserting the cable end into the cable inlet opening in the crimping tool and, after its completion, the processed cable end provided with the contact sleeve is guided out of the crimping tool at the cable outlet opening, wherein the cable outlet opening is different from the cable inlet opening and is arranged opposite the cable inlet opening.

The cable transport device is suitably provided by means of a friction wheel drive arranged adjacent to the cable inlet opening at the cable feed-through with at least two wheels lying opposite each other at the cable feed-through.

The friction wheel drive is designed here to transport the cable, and in particular the cable end that is to be cut, stripped, crimped with the contact sleeve and printed, in the direction R and in the direction opposite the direction R and to position it in the trimming and stripping device, the crimping device and the printing device, in each case for their intended use.

Here, the friction wheel drive is advantageously designed to detect measured values for determining the length of the cable, thereby creating the possibility of cutting a predetermined length of a cable inserted from a cable reel into the crimping tool and thereby providing a second cable end to be crimped. The crimping tool thus advantageously allows a cable that is to be laid and connected to be cut from a cable reel with a predetermined suitable length, in particular also during field use. For this purpose, the friction drive suitably has a drive unit, which can be provided by means of an electric motor, and which can be embodied as a stepper motor, wherein the length of the cable can be determined by detecting the angle of rotation of the wheels or the drive unit of the friction wheel drive.

The trimming and stripping device has at least two knife blades, which are arranged opposite each other at the cable feed-through. The trimming and stripping device is set up here in such a way that in a first position of its knife blades it cuts through or cuts off the cable, and in a second position of the knife blades it cuts into an insulation of the cable, while the conductor of the cable is not cut by the knife blades.

The trimming and stripping device thus has an advantageous dual function, which allows the cable to be cut and stripped, and therefore the crimping tool with the trimming and stripping device can be designed to be particularly compact.

It is clear that the foregoing first position is suitable for trimming the cable to length, and the second position is suitable for stripping the cable and exposing the conductor of the cable. In the second position, that is to say, when stripping the cable, the trimming and stripping device advantageously cooperates with the friction wheel drive, wherein the friction wheel drive provides an axial displacement of the conductor in the direction opposite the direction R for stripping the conductor, so that a portion of the insulation of the cable is pulled from the conductor which is cut and held by the knife blades.

Since only knife blades are moved during operation of the trimming and stripping device, the trimming and stripping device can advantageously be arranged stationary in the crimping tool, so that no further mechanics are required in addition to the drive of the knife blades. As with the crimping device described below, the knife blades can each be driven advantageously by means of a suitable stroke drive, linear drive or suitable piezo actuator.

The crimping device has at least two press elements which are arranged opposite one another on the cable feed-through, wherein the press elements can be suitably driven by a piezo actuator in order to provide a crimping pressure, by means of which, in particular for use for documenting the crimping and the operating state of the crimping device, it is advantageously also possible to measure a crimping pressure or a crimping force of the crimping of a press element.

The printing device is suitably designed to print a region of the cable adjacent to the conductor crimped with the contact sleeve with information characterizing the crimping of the conductor with the contact sleeve. In particular, production order parameters of the crimping can be documented together with information concerning the operating state of the crimping tool during the crimping, such as temperature and an aforementioned crimping pressure and a charging state of the battery, which are suitable for characterizing the quality of the crimping.

The crimping tool can also be suitably networked in terms of signals and data for documentation purposes, so that this information characterizing the crimping and the operating state of the crimping tool can also be documented with network support.

For detecting the above information characterizing the crimping, the crimping tool can have suitable sensors, with at least one temperature sensor and at least one force sensor. For determining the cable length and for positioning a cable end of the cable, in particular in the trimming and stripping device at the cable feed-through, a suitable measuring device can also additionally be provided adjacent to the first friction wheel drive and the trimming and stripping device.

The crimping tool suitably has a camera for hardware- and software-supported reading of production order parameters of a crimping, wherein the crimping tool can interact with a cell phone which provides the production order parameters for reading with the camera on its display. The production order parameters comprise in particular the length and a diameter and a stripping length and the type of cable, which can also be cut from a cable reel by the trimming and stripping device to a length specified by the production order parameters, as well as the contact type of the contact sleeve provided for the crimping.

Reading in the production order parameters by means of the camera is particularly advantageous since the production order parameters can be read in as data and information present as a 2D code, QR code or OCR also from paper besides from the cell phone.

The crimping tool, which is advantageously designed as a mobile hand-held tool, suitably has a housing with an elongate handle, at one end of which an elongate head adjoins, and at the other end of which a foot region adjoins, wherein the head accommodates the cable feed-through with the friction wheel drive, the trimming and stripping device, the crimping device, and the printing device. The housing can suitably be made of plastic or a metal coated with plastic.

The handle suitably accommodates a waste container for collecting cable offcuts and insulation cuttings from the trimming and stripping device and a magazine for feeding contact sleeves to the crimping device, wherein the handle also accommodates a control unit of the crimping tool. The foot region suitably accommodates a battery for power supply.

In this case, the waste container for collecting cable offcuts and insulation cuttings is suitably arranged below the trimming and stripping device in such a way that it extends into the head in the direction of the trimming and stripping device or is accessible via a suitable device for the appropriate supply of cable offcuts and insulation cuttings from the trimming and stripping device.

The magazine for feeding contact sleeves is suitably designed and arranged in such a way that it extends into the head in the direction of the crimping device and is accessible to the crimping device for the corresponding feed of contact sleeves. The contact sleeves can advantageously be designed as twisted contact sleeves. The magazine is set up here in such a way that it can receive a contact sleeve belt with the twisted contact sleeves and can feed a contact sleeve to be crimped to the crimping device, whereby the magazine has the function of a contact sleeve feed device. The magazine can be suitably driven by a stepper motor.

The crimping tool, with its housing having an elongate handle, at one end of which an elongate head adjoins and at the opposite end of which a foot region adjoins, wherein in particular the cable feed-through with its said devices is provided in the elongate head, is advantageously designed both ergonomically and functionally and is correspondingly easy to handle.

Further advantageous details of the crimping tool described above can be found in the following description with reference to FIGS. 1, 2, 3 and 4.

The mobile crimping tool described above is particularly easily handled for crimping a contact sleeve onto a stripped conductor of a cable end, especially in field use, and permits particularly simple crimping of the conductor with the contact sleeve.

Accordingly, the disclosure further relates in particular to a method for crimping a contact sleeve onto an electrical conductor of a cable using the above-described crimping tool, wherein the method uses a method that prepares for the crimping operation, which is suitable in particular for field use of the crimping tool with use of the cell phone as a mobile control unit.

In the method that prepares for the crimping operation, the production order parameters of the crimping can advantageously be determined and compiled in a first step using the cell phone, after which, in a second step, the production order parameters determined and compiled by the cell phone can be displayed on a display of the cell phone and read by the camera of the crimping tool.

The length of the cable to be routed between two predetermined connections in the control cabinet and in a predetermined cable guide rail can be detected optically by the cell phone and then determined with the aid of software. For this purpose, the cell phone can be equipped with a suitable application that allows a photo of a control cabinet, for example, to be shown on the display of the cell phone and the connections to be provided with the cable and the cable guide rail to be marked on the display.

In this way, using the manufacturing order parameters, which may include the length and the diameter and the stripping length and the type of cable and the contact type of the contact sleeve, the crimping tool can advantageously be easily brought in a third step into a first operating state which allows a predetermined crimping of the cable with the contact sleeve characterized by the manufacturing order parameters.

Suitably, in a fourth step of the method that prepares for the crimping operation, it can be checked whether a contact sleeve to be crimped is arranged in its intended position in the crimping device and, if necessary, fed to the crimping device.

After carrying out the method that prepares for the crimping operation, the crimping tool is set up for assembling a cable by crimping contact sleeves onto its two cable ends and for carrying out a corresponding first and second method for crimping a first and second cable end, respectively, the individual method steps of which, together with further features of the above method that prepares for the crimping operation, are described in detail in the following description of an advantageous exemplary embodiment with reference to FIG. 5.

### BRIEF DESCRIPTION OF THE DRAWINGS

Exemplary embodiments of the invention are shown in the drawings and will be explained in greater detail below.

FIG. 1A shows a schematic side view of a crimping tool together with a cable end to be crimped and a contact sleeve;

FIG. 1B shows a detail of the crimping tool of FIG. 1A from a different perspective;

FIG. 1C shows the cable and the contact sleeve of FIG. 1A, each from a different perspective;

FIG. 2 shows a schematic side view of a crimping tool together with a cable end to be crimped and a contact sleeve;

FIG. 3A shows an enlarged schematic representation of elements of a cable transport device of a crimping tool of FIGS. 1A and 2;

FIG. 3B shows an enlarged schematic representation of elements of a trimming and stripping device of a crimping tool of FIGS. 1A and 2 together with a cable;

FIG. 3C shows the trimming and stripping device of FIG. 3B in a first working position;

FIG. 3D shows the trimming and stripping device of FIG. 3B in a second working position;

FIG. 4A shows an enlarged schematic representation of elements of a crimping device of a crimping tool of FIGS. 1A and 2 together with a cable end and a contact sleeve;

FIG. 4B shows elements of a contact sleeve feed device of a crimping tool of FIGS. 1A and 2; and

FIG. 5 shows a flow diagram of method steps of a method for crimping a contact sleeve onto an electrical conductor of a cable.

### DETAILED DESCRIPTION

The figures contain partially simplified, schematic representations. In part, like reference signs are used for like, but possibly not identical elements. Different views of like elements may be scaled differently.

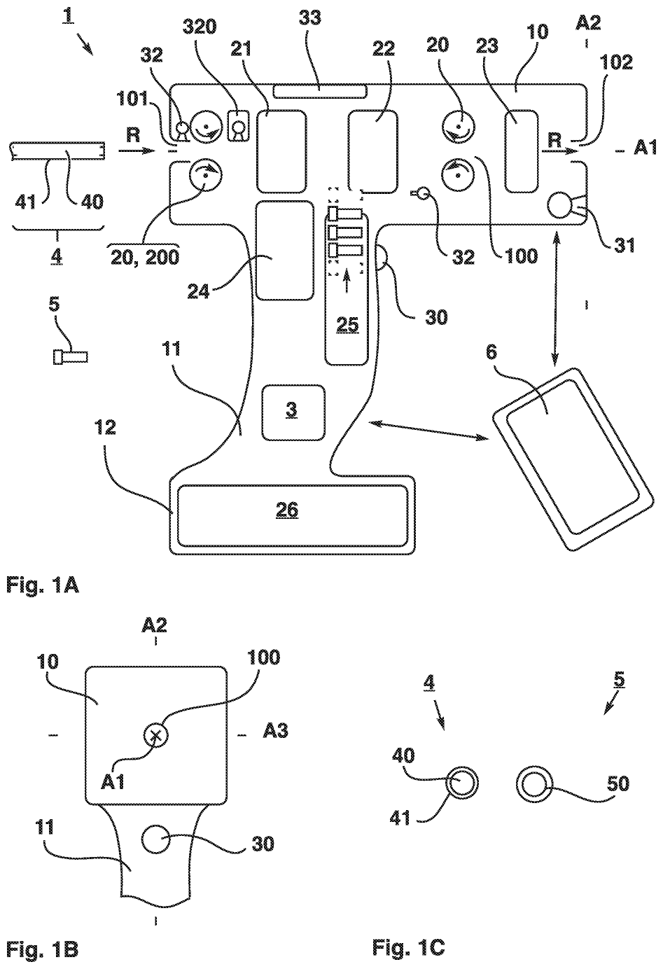

FIG. 1A shows a schematic side view of a crimping tool 1 for crimping a contact sleeve 5 onto an electrical conductor 40, together with a cable end of a cable 4 to be crimped and a contact sleeve 5. The crimping tool 1 has a housing which is advantageously formed both ergonomically and functionally, with an elongate handle 11, at one end of which an elongate head 10 adjoins and at the opposite end of which a foot region 12 adjoins. The housing may suitably be formed of plastic or of a metal coated with plastic and accommodates a plurality of functional devices in its interior.

FIG. 1B shows, in combination with FIG. 1A, a detail of the crimping tool 1 from another perspective, namely rotated through 90° from the drawing plane and in the opposite direction to the direction R of FIG. 1A, which indicates a cable insertion direction and cable feed-through direction R of a cable 4. In this regard, FIG. 1C shows a plan view of the cable 4 and the contact sleeve 5 of FIG. 1A, in each case in their axial directions. The cable 4 has a conductor 40 which is provided with an insulation 41. The contact sleeve 5 has an inner edge 50 corresponding to the conductor 40 for the insertion of the conductor 40. The conductor 40 may be a single wire, a wire mesh, a core or a stranded wire. The contact sleeve 5 may in particular be a twisted contact sleeve 5.

The elongate head 10 has a central elongate cable feed-through 100 open on both sides and extending rectilinearly along a central axis A1. The head 10 accommodates in its interior a cable transport device 20, a trimming and stripping device 21, a crimping device 22, by way of example a further cable transport device 20, and a printing device 23, which are arranged in this order in the cable insertion direction R along the cable feed-through 100. The above-first-mentioned cable transport device 20 is thereby arranged adjacent to an opening 101 of the cable feed-through 100 provided for the insertion of the cable 4. The two further axes A2 and A3 each extend perpendicularly to each other and to the axis A1, wherein the axis A2 extends centrally through the head 10, the handle 11 and the foot region 12.

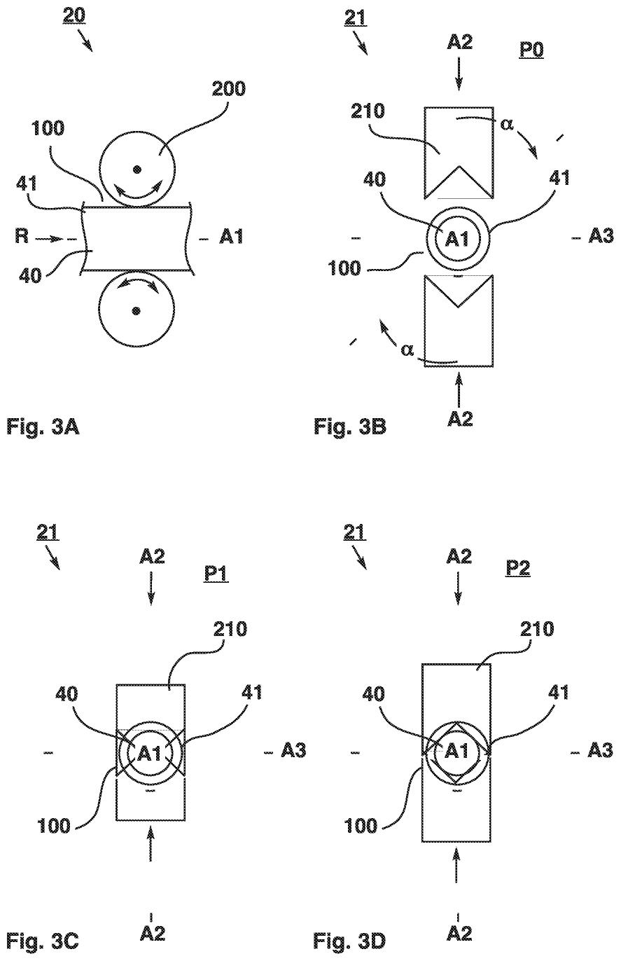

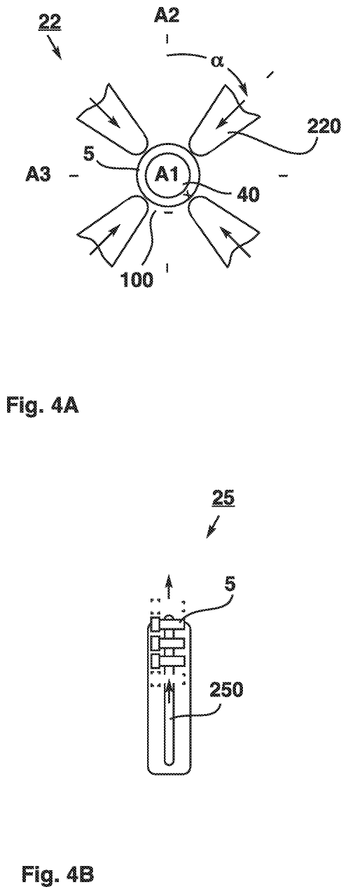

The aforementioned devices 20, 21, 22, and 23 each have suitable functional elements, each of which can interact with drives and/or control elements not shown in the drawing for reasons clarity and convenience. Details of the cable transport device 20, the trimming and stripping device 21, and the crimping device 22 are described below with reference respectively to FIGS. 3A, B, C and D and FIGS. 4A and B.

The printing device 23 is arranged adjacent to a cable outlet opening 102 of the cable feed-through 100 for printing on the cable 4 crimped with a contact sleeve 5 and has a printing unit in the region of the cable feed-through 100, for the provision of which techniques such as, in particular, inkjet, hot stamping, laser, pad, stamp printing, etc. are suitable. The printing can be carried out here directly on the cable 4 or indirectly on an adhesive label. For direct printing on the cable 4, the cable 4 is passed in front of the printing unit by means of the cable transport device 20. For indirect printing, a label is first printed and then the printed label is subsequently applied to the cable 4, for example as a cable flag. It is clear that such a printing device 23 indirectly printing the cable 4 has a raw label store for this purpose.

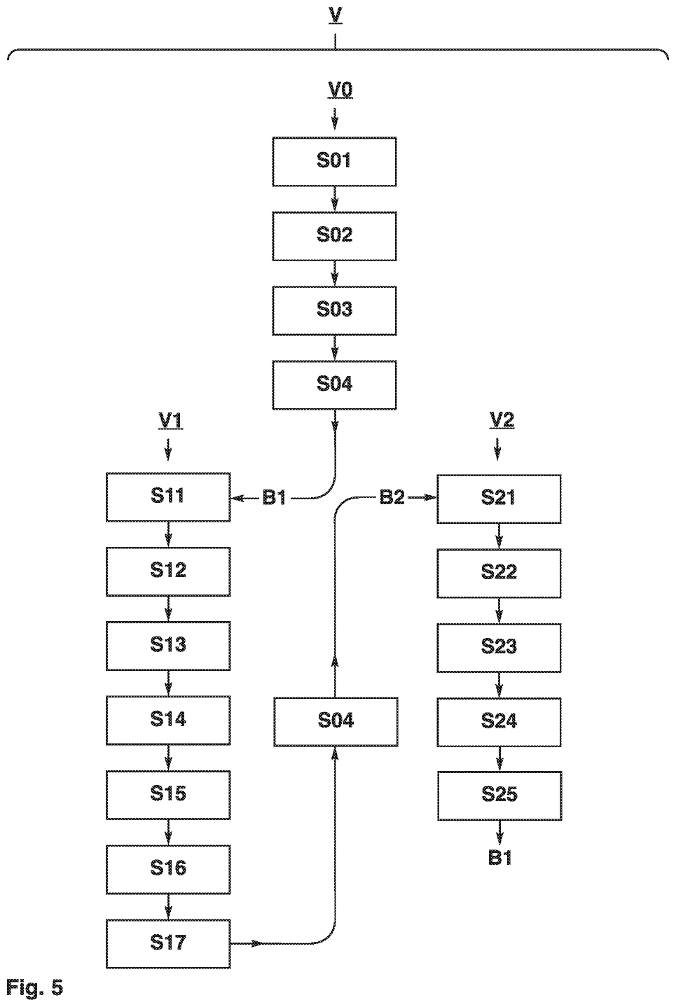

Suitable print data and information suitable for characterizing the cable 4 and its crimping may include, in particular, signal data from the sensors 31 and 32 described below and further information and further details such as manufacturing order parameters of the crimping, which will be described below in the description of the camera 31 and additionally with reference to FIG. 5 together with a crimping method according to one embodiment.

Here, the elongate head 10 has a first optical sensor 31 and a plurality of further sensors 32 as well as a display device 33 for displaying, in particular, an operating state of the crimping tool 1. The optical sensor 31 is designed as a camera 31 and is arranged adjacent to the opening 102 of the cable feed-through 100 with its optical axis parallel to the axis A1. The camera 31 and the further sensors 32 interact with an electronic control unit 3, which may be more suitably accommodated in the handle 11. In addition to the optical display device 33, the crimping tool 1 may also include means for acoustically indicating an operating condition.

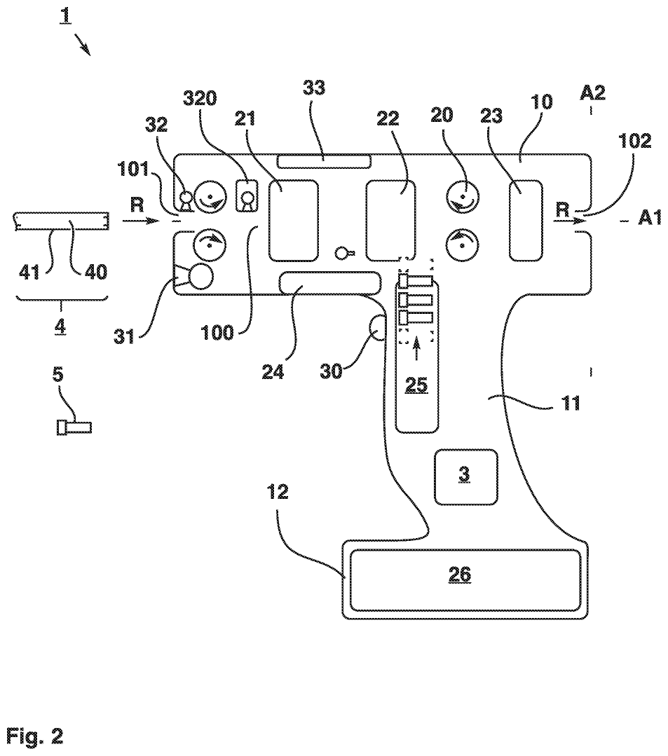

The camera 31 is provided in particular for reading in data and information present as a 2D code, QR code or OCR, such as in particular production order parameters comprising in particular a predetermined cable length L and a diameter and a stripping length and the type of cable 4 and the contact type of the contact sleeve 5. For reading in data and information present as text, the control unit 3 cooperating with the camera 31 may have suitable text recognition software. The data and information captured by the camera 31 are suitable for characterizing the crimping of the cable 4, and thus for printing on the cable 4. Further details and features of the camera 31 are described below with reference to FIG. 2 and to FIG. 5, together with a crimping method according to one embodiment.

The handle 11 also includes, in its interior, a waste container 24 for collecting cable offcuts and insulation cuttings, and a magazine 25 for feeding contact sleeves 5 to the crimping device 22. The cable offcuts and insulation cuttings collected by the waste container 24 can be collected in the waste container 24 and fed to the material cycle as needed. The magazine 25 is designed to receive a contact sleeve belt 250 with, in particular, twisted contact sleeves 5 and to feed a contact sleeve 5 to be crimped to the crimping device 22, after which the magazine 25 has the function of a contact sleeve feed device 25. The magazine 25 is designed here to accommodate the contact sleeve belt 250 both as a strip-like portion and in coiled form, and to feed it to the crimping device 22.

The waste container 24 is designed and arranged to extend into the head 10 in the direction of the trimming and stripping device 21 or to be accessible via a suitable device for the corresponding supply of cable offcuts and insulation cuttings from the trimming and stripping device 21. In this respect, the magazine 25 is designed and arranged to extend into the head 10 in the direction of the crimping device 22 and to be accessible to the crimping device 22 for the corresponding supply of contact sleeves 5. Further details and features concerning the magazine 25 are described below with reference to FIG. 4B.

A manually operable switching device is also provided on the handle 11 as an operating element 30, which interacts with the control unit 3 and by means of the actuation of which predetermined operating states of the crimping tool 1 can be provided.

With the above-described electrical, electronic or electromechanical functional elements, units and devices accommodated in the head 10 and the handle 11, namely the operating element 30, the sensors 31 and 32, the control unit 3, the display device 33, at least one cable transport device 20 adjacent to the cable inlet opening 101, the trimming and stripping device 21, the crimping device 22, the printing device 23, the waste container 24 and the contact sleeve feed device 25, a multifunctional crimping tool 1 is provided, which has a multiplicity of also variable possibilities for the complete comprehensive preparation of a conductor 40 of a cable 4 to be crimped with a contact sleeve 5, wherein, for its operation, a battery 26 is lastly accommodated in the foot region 12.

Purely by way of example, the second friction wheel drive 20 is arranged between the crimping device 22 and the printing device 23 and can also be arranged adjacent to the trimming and stripping device 21 and the crimping device 22 between these devices or adjacent to the first friction wheel drive 20. In the case of a mirror-image arrangement of a further magazine 25 and a further suitable crimping device 22, which is not shown in the drawing, crimping of both cable ends with contact sleeves 5 can also be carried out with a single insertion of the cable 4. It is clear that the friction wheel drive 20, the trimming and stripping device 21, the magazines 25 and the crimping devices 22 are suitably arranged on the cable feed-through 100 for this purpose and are suitably controlled.

The sensors 31 and 32 are in signal connection with the control unit 3 for detecting operating states of the crimping tool 1. The further sensors 32 may be suitable further optical sensors, mechanical sensors and temperature sensors suitable for detecting an operating state of at least one device of the crimping tool 1. The electronic control unit 3 can suitably comprise a microcontroller, a microprocessor and a memory unit as well as a suitable interface for bidirectional wireless signal and/or data transmission, in particular via Bluetooth.

The control unit 3 equipped in this way is thus able to monitor and control the operation of the crimping tool 1 with hardware and software support and to log it in the form of data, wherein the software for this can be available on the memory unit of the control unit 3. In addition, the control unit 3 can be suitably networked with Bluetooth support to a mobile control unit 6, which can in particular be a cell phone 6. The mobile control unit 6 can further suitably interact with the camera 31, which is described below with reference to FIG. 5 together with a crimping method according to one embodiment.

With reference to FIGS. 1A, B and C, in particular essential elements and devices and their arrangement of the thus multifunctional crimping tool 1 have been described above. In particular, functional details of the features of the individual elements and devices of the crimping tool 1 and their interaction during its operation are described below with reference to FIGS. 3A, B, C and D and FIGS. 4A and B. A method for crimping a contact sleeve 5 onto an electrical conductor 40 of a cable 4, in particular using the crimping tool 1 according to one embodiment, is described below with reference to FIG. 5.

In the following, an exemplary modification of the crimping tool 1 is described with reference to FIG. 2. For this purpose, FIG. 2 shows a crimping tool 1 according to one embodiment together with a cable end of a cable 4 to be crimped and a contact sleeve 5. The cell phone 6 is not shown in FIG. 2 and reference is made here to FIG. 1A in this respect. The crimping tool 1 of FIG. 2 differs from the embodiment of FIG. 1A substantially in the arrangement of its head 10 relative to the handle 11. The handle 11 is rotated here through 180° relative to the head 10 compared to the embodiment of FIGS. 1A and 1s arranged offset in the cable feed-through direction R, whereby the crimping tool 1 is ergonomically particularly easily handled by an operator who prefers handling of the crimping tool 1 as similar as possible to the handling of an electric drill or a cordless screwdriver.

Namely, during operation of the crimping tool 1 of FIG. 2, the cable 4 is inserted into the opening 101 of the cable feed-through 100 spaced from the handle 11. Furthermore, the cable 4 crimped with a contact sleeve 5 is led out of the crimping tool 1 directly in the direction R towards the operator at the opposite opening 102 of the cable feed-through 100.

Furthermore, unlike in the embodiment of FIG. 1A, the camera 31 is arranged adjacent to the opening 101 for inserting the cable 4. In this arrangement, the camera 31 can also easily record, in particular, image data of a cable 4 before its insertion into the crimping tool 1, said data also being suitable for documenting the crimping.

The waste container 24 is comparatively small compared to the embodiment of FIGS. 1A and 1s provided only in the head 10, wherein the waste container 24 is also arranged adjacent to and below the trimming and stripping device 21 for receiving and collecting cable offcuts and insulation cuttings.

FIG. 3A shows an enlarged schematic representation of two friction wheels 200 of a cable transport device 20 of a crimping tool of FIGS. 1A and 2. The cable transport device 20, suitably provided by means of at least one friction wheel drive 20, has at least two wheels 200 arranged tangentially to the axis A1, which are designed as friction wheels 200. The friction wheel drive 20 is designed, set up and arranged in such a way that it grasps the cable 4 manually inserted via the opening 201 and rotates, thereby displacing and transporting the cable 4, until a predetermined displaced cable length is reached for positioning the cable 4 as intended.

The cable length can be determined here at the friction wheel drive 20 by detecting the angle of rotation of the friction wheels 200 or a drive unit of the friction wheel drive 20. Alternatively, a direct length measurement can be carried out on the cable 4 led through, for example by means of a suitable optical or mechanical measuring device 320 which is arranged adjacent to the friction wheel drive 20 and which has further sensors 32 and is also connected to the control unit 3 in terms of signals and data.

The friction wheel drive 20 is suitably set up here in such a way that it can transport the cable 4 in the cable feed-through direction R and can also transport it against the cable feed-through direction R. These two transport directions of the cable 4 in the cable feed-through 100 are used successively during operation of the crimping tool 1, in particular during stripping of the conductor 40 at the cable end of the cable 4, wherein the friction wheel drive 20 advantageously cooperates with the trimming and stripping device 21 described below with reference to FIGS. 3B, C and D.

In the embodiment of FIGS. 1A and 2, a further optical or mechanical sensor 32 mentioned above is arranged adjacent to the opening 101 and the friction wheel drive by means of which, for example, a first insertion of a cable 4 into the opening 101 can be detected, whereupon a corresponding signal from the sensor 32 can be sent to the control unit 3 so that the crimping machine 1 can be set to a predetermined operating state. For example, in this operating state the cable transport device 20, and/or the trimming and stripping device 21, etc., can be moved from a rest position to a first working position.

In addition to the optical sensor 32 described above, another such optical sensor 32 not shown in the drawings of FIGS. 1A and 2 can be arranged adjacent to the opening 102 on the cable feed-through 100 so that an exit of the cable 4 from the opening 102 is detectable, and whereupon the crimping machine 1 can also be set to a correspondingly predetermined operating state.

To display an operating state of the crimping tool 1, a display device 33 can be provided on the crimping tool 1 and/or the operating state can be sent to the mobile control unit 6, in particular via Bluetooth, and displayed thereby and also documented with network support. In particular, a change in an operating state can also be indicated acoustically by means of a suitable device.

FIG. 3B shows an enlarged schematic view of elements of a trimming and stripping device 21 of a crimping tool 1 from FIGS. 1A and 2 together with a cable detail of a cable 4 in a rest position P0.

The trimming and stripping device 21 suitably has two knife blades 210 with selectable cutting geometries, wherein the knife blades 210 are advantageously used for cutting or trimming the cable 4 and also for subsequently stripping the previously cut cable end, wherein the insulation 41 of the cable end is stripped and the conductor 40 to be crimped is exposed. The knife blades 210 are arranged mirror-symmetrically opposite each other with respect to the axis A1 of the cable feed-through 100, and the cable 4 is arranged between the knife blades 210 in the cable feed-through 100 as shown in FIG. 3B.

In the rest position P0, the knife blades 210 are spaced apart from each other and from the cable 4. The trimming and stripping device 21 can be arranged with its knife blades 210 parallel to the axis A2 on the cable feed-through 100, as shown in FIG. 3B. It is clear that the trimming and stripping device 21 can also be arranged with its knife blades 210 parallel to the axis A3 or pivoted relative to the axis by an angle α of suitably 45°, whereby a particularly compact design of the head 10 is possible.

The trimming and stripping device 21 is set up in such a way that its knife blades 210 are moved axially towards each other during cutting or trimming and during stripping. Depending on the travel path of the knife blades 210, this results in a cutting or trimming of the cable 4, namely when the knife blades 210 are moved together beyond their cutting edge. This position P1, which is suitable for trimming or cutting the cable end of the cable 4, is shown schematically in FIG. 3C.

During stripping, the knife blades 210 are moved towards each other by a predetermined amount by the trimming and stripping device 21, so that a gap remains between the knife blades 210 for the conductor 40 to be stripped. This position P2 of the knife blades 210, suitable for stripping the insulation 41, is shown in FIG. 3D. Here, as said above, the trimming and stripping device 21 suitably cooperates with the friction wheel drive 20, which provides an axial movement in the opposite direction to the cable feed-through direction R for stripping the conductor 40, so that a portion of the insulation 41 of the cable 4 is pulled from the conductor 40 which is cut and held by the knife blades 210, while the cable 4 with the stripped conductor 40 is pulled out of the trimming and stripping device 21 by the friction wheel drive 20 in the direction opposite the cable feed-through direction R.

Since only the knife blades 210 of the trimming and stripping device 21 are moved during operation, the trimming and stripping device 21 can advantageously be arranged stationary in the crimping tool 1, whereby no further mechanics are required in addition to the drive of the knife blades 210. Alternatively, a corresponding axial movement of the knife blades 210 of the trimming and stripping device 21 in the cable feed-through direction R is possible with the cable 4 held in place by the friction wheel drive 20.

FIG. 4A shows an enlarged schematic representation of elements of a crimping device 22 of a crimping tool 1 from FIGS. 1A and 2 together with a stripped conductor 40 of a cable 4 and a contact sleeve 5, which for crimping are positioned in the crimping device 22 as intended, in a first working position. For this purpose, FIG. 4B shows elements of a contact sleeve feed device 25 of the crimping tool 1, in which the contact sleeves 5 in the magazine of the contact sleeve feed device 25 are successively fed to the crimping device 22 in a row on a contact sleeve belt 250, wherein the contact sleeve feed device 25 continues to feed the contact sleeve belt 250 by a predetermined belt pitch distance after a crimping has taken place. The contact sleeve feed device 25 can be suitably driven by a stepper motor.

The crimping device 22 has a contact belt separating device, not shown, by means of which the next contact sleeve 5 present and fed to the crimping device 22 by the contact sleeve feed device 25 can be separated from the contact sleeve belt 250. In addition, the crimping device 22 has a contact positioning device, not shown, by means of which a contact sleeve 5 separated by the contact belt separating device and gripped by the crimping device 22 can be positioned in the crimping device 22 for its intended crimping onto a stripped conductor 40 of a cable 4.

For this purpose, FIG. 4A shows a first working position of the crimping device 22, in which the contact sleeve 5 in the crimping device 22 is arranged as intended at a central position in the cable feed-through 100 in axial alignment A1 with the conductor 40. It is clear that in this case the contact terminal side faces the already stripped conductor 40, wherein in the working position of the crimping device 22 of FIG. 4A a conductor 40 is already inserted into the contact sleeve 5 as intended by means of the friction wheel drive 20 for crimping.

The embodiment of the crimping device 22 of FIG. 4A suitably has four mandrels 220 as press elements 220, the drive of which in the direction of the arrow of FIG. 4A can be effected via a stroke drive. As an alternative to this, a suitable linear drive, and in particular advantageously a suitable piezo actuator or a suitable spindle stroke axis can each drive a mandrel 220, whereby process force monitoring of each mandrel 220 is advantageously made possible. The respective drive force can also be effected by means of toggle levers in the case of the drives mentioned. The mandrels 220 of the crimping device 22 are suitably arranged pivoted by an angle α of 45° with respect to the two axes A2 and A3 perpendicular to each other and to the axis A1, which permits a particularly compact design of the head 10 of the crimping tool 1. It is clear that the crimping tool 1 can also have a double mandrel crimping device 22 instead of the four mandrel crimping device as per the embodiment of the crimping device 22 of FIG. 4A.

The friction wheel drive 20, the trimming and stripping device 21, the crimping device 22 and the contact sleeve feed device 25 can each have an individual drive as described above, wherein a suitable central drive with corresponding mechanical conversion devices for the partial movements to be carried out can also be provided instead.

FIG. 5 shows a flow diagram of method steps of a method V for crimping a contact sleeve 5 onto an electrical conductor 40 of a cable 4 according to one embodiment, wherein the above-described crimping tool 1 is particularly suitable for use in the method V. Furthermore, the method is particularly suitable for carrying out mobile electrical installation work, for example in the case of control cabinet removal, which is carried out in particular in field processing by a professional electrical installation company.

In the method V, the following steps S01 to S04 of an advantageous method V0 that prepares for the crimping operation are carried out first.

Firstly, in a first step S01 that prepares for the crimping of the two cable ends of a cable 4, production order parameters are determined, compiled and suitably prepared for their use in a crimping operation by means of the crimping tool 1. The production order parameters can be, in particular, a length L of a cable 4 to be laid and mounted in a switch cabinet, as well as a diameter and a stripping length and the type of cable 4 and the contact type of the contact sleeve 5 provided.

The length L of the cable 4 to be laid between two predetermined connections in the switch cabinet and at the same time in a predetermined cable guide rail can be determined particularly advantageously by a cell phone 6 equipped with suitable hardware and software, first optically and then with software support. It is clear that the cell phone 6 is equipped with a suitable application for this purpose, which allows a photo of, for example, a switch cabinet to be shown on the display of the cell phone 6 and the connections to be provided with the cable 4 and the cable guide rail to be marked on the display.

In a second step S02 that prepares for the crimping operation, the production order parameters determined and compiled in step S01 are recorded by the crimping tool 1 using the camera 31. The production order parameters can be in the form of a 2D code, QR code or plain text and can be displayed by the application of the cell phone 6 on its display. It is clear that for this purpose the camera 31 of the crimping tool 1 is suitably positioned by an operator and the crimping tool 1 is brought here into a suitable operating state by means of the operating element 30.

As an alternative to the production order parameters shown in step S02 by means of the cell phone 6 as a 2D code, QR code or plain text on its display, these can also be available on paper and can also be read in from paper by the camera 31. The data transmission of the production order parameters from the cell phone 6 to the control unit 3 of the crimping tool can also take place via Bluetooth.

In a third step S03 that prepares for the crimping operation, the production order parameters read in by the camera 31 or via Bluetooth are determined in terms of signals and data by the control unit 3 and are evaluated with software support, whereupon the control unit 3 sets the crimping tool 1 to a first operating state B1, which is suitably displayed on the display device 33 of the crimping tool 1. The first operating state B1 is characterized here in that the acquisition of the production order parameters and their evaluation is completed and the crimping tool 1 is ready for carrying out an assembly of a cable 4 by means of crimping a first contact sleeve 5 onto a first cable end of the cable 4 and for inserting the cable 4 for this purpose.

In a fourth step S04 that prepares for the crimping operation, it is first checked whether a contact sleeve 5 to be crimped is present at its intended position in the crimping device 22 in accordance with the production order parameters and, if necessary, whether a contact sleeve 5 is fed to the crimping device 22 from the contact sleeve feed device 25, wherein the contact sleeve 5 is gripped by the crimping device 22 and positioned in the crimping device 22 at a central position in the cable feed-through 100 in axial alignment A1 with the conductor 40. For details of step S04, reference is made here to the foregoing description of the crimping device 22 and the contact sleeve feed device 25 with reference to FIGS. 4A and B.

After steps S01 to S04 of the method V0 that prepares for the crimping operation have been completed, the subsequent steps S11 to S17 of a first method V1 for crimping a first cable end of the cable 4 with a contact sleeve 5 are carried out in the method V in the first operating state B1 of the crimping tool 1.

In a first step S11 for crimping a first cable end with a contact sleeve 5, the cable 4 is inserted by the operator into the cable inlet opening 101 of the crimping tool 1 for crimping with a contact sleeve 5 in the first operating state B1 of the crimping tool 1. The cable 4 is gripped here by the friction wheel drive 20 and guided in the cable feed-through direction R of the cable feed-through 100 of the crimping tool 1 to the trimming and stripping device 21 and is inserted into the trimming and stripping device 21 by a predetermined amount by which the first cable end is cut.

In a second step S12 for crimping the first cable end, the cable 4 inserted by the predetermined amount into the trimming and stripping device 21 and positioned accordingly is cut by the trimming and stripping device 21, wherein the cut length corresponds to the amount of cable 4 inserted into the trimming and stripping device 21.

In this way, the flushness of the insulation 41 with the conductor 40 at the end of the cable is advantageously ensured so that, when the cable 4 is stripped, a stripped conductor 40 of a desirable predetermined length is provided which corresponds to a predetermined contact sleeve 5 for crimping. In the second step S12, for this purpose, the knife blades 210 of the trimming and stripping device 21 are moved from their rest position P0 of FIG. 3B to the position P1 of FIG. 3C and are brought back to the position P0. In step S12, the cut cable offcuts are also fed to the waste container 24 from a discharge means of the trimming and stripping device 21.

In a third step S13 for crimping the first cable end, the cable 4 is stripped by the trimming and stripping device 21, wherein the trimming and stripping device 21 suitably cooperates here with the friction wheel drive 20. Firstly, the cable 4 cut in step S12, which remains with its cable end at a defined position in the cable feed-through 100 during cutting, is transported in the direction R by a predetermined amount corresponding to the length of the first cable end to be stripped. Following this, the knife blades 210 of the trimming and stripping device 21 are brought into the position P2 of FIG. 3D and, in the process, the insulation 41 of the cable 4 is cut in as far as the conductor 40.

While the knife blades 210 remain in position P2, the cable 4 with the conductor 40 is transported by the friction wheel drive 20 by the above predetermined amount in the direction opposite the direction R, wherein the knife blades 210 hold the insulation 41 of the cable 4 so that the conductor 40 is exposed with a predetermined length at the cable end. In step S13, moreover, the stripped insulation cutting is supplied to the waste container 24 from the discharge means of the trimming and stripping device 21. It is understood that step S13 is suitably performed subsequently to step S12.

In a fourth step S14 for crimping the first cable end, the cable 4 is transported by the friction wheel drive 20 in the direction R and fed to the crimping device 22 and axially inserted with the stripped conductor 40 at its cable end into the contact sleeve 5 positioned in the crimping device. Following this, the crimping device 22 crimps the contact sleeve 5 to the conductor 40. For details of step S14, reference is also made here to the above description of the crimping device with reference to FIG. 4A.

Following step S14, the first cable end of the cable 4 crimped with the contact sleeve 5 is transported in a fifth step S15 from the friction wheel drive 20 in the direction R to the printing device 23 for crimping the first cable end, and the first cable end of the cable 4 is printed by the printing device 23 with the production order parameters and with further information characterizing the crimping. The further data characterizing the crimping is constituted by values detected by sensors 31 and 32 of the crimping tool 1, such as temperature and pressure, as well as a suitably monitored charge state of the battery 26, which are suitable for characterizing the quality of the crimping.

The crimping performed can also be transmitted to the cell phone 6, in particular via Bluetooth, together with its production order parameters and other information characterizing the crimping, whereupon the crimping can be documented on the cell phone 6 and also with network support.

It is clear that the length of the cable feed-through 100 is known, and thus the length of the cable 4 inserted into the cable feed-through 100 in step S15 is also known. Furthermore, when the cable 4 is transported by the friction wheel drive 20, the above steps S11 to S15 are each suitably performed while detecting the displacement of the cable 4 by the friction wheel drive 20 or a measuring device 320. For details, reference is made here to the description of FIGS. 1 and 3A.

Following step S15, in a sixth step S16 for crimping the first cable end, the first cable end of the cable 4 printed by the printing device 23 is transported by the friction wheel drive 20 in the direction R to a position in which the first cable end already crimped by the knife blades 210 of the trimming and stripping device 21 has a distance along the cable 4 corresponding to the length L determined in step S01. In this case, the first cable end crimped and printed with the contact sleeve 5 has already emerged from the cable outlet opening 102 of the cable feed-through 100. The length L can be determined here by a measuring device 320 or advantageously directly at the friction wheel drive 20. In this position, the cable 4 is cut by the trimming and stripping device 21, and in this way the second cable end and the cable 4 with the cable length L are provided.

Lastly, in a seventh step S17 for crimping the first cable end, the crimping tool 1 is brought into a second operating state B2. This operating state B2 and the successful execution of steps S11 to S16 are suitably indicated visually or acoustically, in particular also on the display device 33, after which the cable 4 is completely pulled out of the crimping tool 1 by the operator.

The second operating state B2 is characterized here in that the crimping of the first contact sleeve 5 onto the first cable end of the cable 4 is completed and the crimping tool 1 is ready for removal of the cable 4 and for further insertion of the cable 4 for crimping the second cable end of the cable 4 with a contact sleeve 5, wherein in the second operating state the step S04 is first performed again and accordingly a new contact sleeve 5 for receiving the conductor 40 of the second stripped cable end is positioned in the crimping device 22 as intended.

After steps S11 to S17 of the method V1 have been successfully completed, the method V in the second operating state B2 of the crimping tool 1 performs the subsequent steps S21 to S25 of a second method V2 for crimping a second cable end of the cable 4 with a contact sleeve 5.

In the operating state B2, the cable 4 with its, as yet, uncrimped second cable end is inserted by the operator into the cable inlet opening 101 of the crimping tool 1 for crimping with a contact sleeve 5 in a first step S21 for crimping the second cable end with a contact sleeve 5. The cable 4 is gripped here by the friction wheel drive 20 and inserted in the cable feed-through direction R of the cable feed-through 100 of the crimping tool 1 to the trimming and stripping device 21 and by a predetermined amount into the trimming and stripping device 21, by which the second cable end is cut like the first cable end.

In a second step S22 for crimping the second end of the cable, the cable 4 inserted by the predetermined amount into the trimming and stripping device 21 and positioned accordingly is cut by the trimming and stripping device 21, wherein the cut length corresponds to the amount of the cable 4 inserted into the trimming and stripping device 21. In this way, it is advantageously ensured that, when the cable 4 is stripped, a stripped conductor 40 of a desirable predetermined length is provided which corresponds to a predetermined contact sleeve 5 for crimping.

Accordingly, the first S21 and second S22 steps for crimping the second cable end correspond respectively to the first S11 and second S12 steps for crimping the first cable end.

It is clear that in the above-described sixth step S16 of trimming the cable 4 to length by means of the trimming and stripping device 21, and providing the second cable end and the cable 4 with the cable length L, the above predetermined amount by which the second cable end is also cut is taken into account to ensure that, when the cable 4 is stripped, a stripped conductor 40 of a desirable predetermined length, which is suitable for crimping with a predetermined contact sleeve 5, is provided.

In a third step S23 for crimping the second cable end, the conductor 40 is exposed at a predetermined length at the second cable end by means of the trimming and stripping device 21, analogously to the third step S13 described above, and therefore reference is made to the description of step S13 in this respect.

In a fourth step S24 for crimping the second cable end, the crimping of the stripped conductor 40 with the contact sleeve 5 is carried out by means of the crimping device 22, analogously to the fourth step S14 described above, and therefore reference is made to the description of step S14 in this respect.

In a fifth step S25 for crimping the second cable end, a region of the cable 4 adjacent to the cable end crimped with the contact sleeve 5 is printed analogously to the fifth step S15 described above, and therefore reference is made to the description of step S15 in this regard.

Following step S25, the cable 4 with its crimped two cable ends is removed from the crimping tool 1 and the crimping tool 1 is suitably set again to the first operating state B1, wherein, in addition, step S04 is carried out again and, accordingly, a new contact sleeve 5 for receiving a conductor 40 of a stripped cable end is positioned in the crimping device 22 as intended.

As described above, the crimping tool 1 is thus ready for crimping a first cable end of a cable 4 with a contact sleeve and for trimming the cable 4 to length according to the settings of the crimping tool 1 made by means of steps S01 to S03. It is clear that steps S01 to S03 can also be executed again by the crimping tool 1 and the cell phone 6 in order to read in new production parameters of a further job for assembling a further cable 4.

It is clear that the crimping tool 1 is also set up so that the first operating state B1 and the second operating state B2 described above, as well as the individual process steps S11 to S17 and S21 to S25, can each also be set manually by an operator by means of corresponding actuation of the operating element 30.

Even though various aspects or features of the invention are shown in each case in combination in the figures, it is apparent to those skilled in the art—unless otherwise indicated—that the combinations shown and discussed are not the only possible ones. In particular, corresponding units or feature complexes from different exemplary embodiments may be interchanged.

### LIST OF REFERENCE SIGNS

1 crimping tool
10 head
100 cable feed through
101 opening, cable inlet opening
102 opening, cable outlet opening
11 handle
12 foot region
20 cable transport device, friction wheel drive
200 wheel, friction wheel
21 trimming and stripping device
210 blade, knife blade
22 crimping device
220 press element, mandrel
23 printing device
24 waste container
25 contact sleeve feed device, magazine
250 contact sleeve belt
26 battery
3 control unit
30 switching device, operating element
31 optical sensor, camera
32 sensor
320 measuring device
33 display device
4 cable
40 conductor, stranded wire, core, wire
41 insulation
5 contact sleeve
50 inner edge
6 mobile control unit, cell phone
A1, A2, A3 axis
α angle
B1, B2 operating state
L length, cable length
P0, P1, P2 position
R direction, cable insertion direction, cable feed through
direction
S01, S02, S03, S04 step
S11, S12, S13, S14, S15, S16, S17 step
S21, S22, S23, S24, S25 step
V, V0, V1, V2 method

1.-12. (canceled)

13. A crimping tool (1) for crimping a contact sleeve (5) onto an electrical conductor (40) of a cable (4), comprising:
a cable transport device (20);
a trimming and stripping device (21);
a crimping device (22); and
a printing device (23),
arranged successively in a direction (R) on a cable feed through (100) of the crimping tool (1) with an axis (A1),
wherein the crimping tool (1) is designed in such a way that a cable end of the cable (4) inserted via a cable inlet opening (101) of the cable feed through (100) is fed from the cable transport device (20) in the direction (R) to the trimming and stripping device (21), the crimping device (22), and the printing device (23), and is then led out of the crimping tool (1) via a cable outlet opening (102) of the cable feed through (100) opposite the cable inlet opening (101).

14. The crimping tool (1) as claimed in claim 13, wherein
the cable transport device (20) is provided by a friction wheel drive (20) arranged adjacent to the cable inlet opening (101) at the cable feed through (100) with at least two wheels (200) lying opposite each other at the cable feed through (100),
wherein the friction wheel drive (2) is set up such that the cable (4) can be transported and positioned in the direction (R) and in the direction opposite the direction (R), and
wherein the friction wheel drive (20) is set up to detect measured values for determining a length (L) of the cable (4).

15. The crimping tool (1) as claimed in claim 14,
wherein the trimming and stripping device (21) has at least two knife blades (210), which are arranged opposite each other at the cable feed through (100),
wherein the trimming and stripping device (21) is set up in such a way that in a first position (P1) of the at least two knife blades (210) it cuts through or cuts off the cable (4), and in a second position (P2) it cuts into an insulation (41) of the cable (4), while the electrical conductor (40) of the cable (4) is not cut by the at least two knife blades (210),
wherein the first position (P1) is suitable for trimming the cable (4) to length and the second position (P2) is suitable for stripping the cable (4) and exposing the electrical conductor (40), and
wherein in the second position (P2) for stripping the cable (4), the trimming and stripping device (21) cooperates with the friction wheel drive (20).

16. The crimping tool (1) as claimed in claim 13,
wherein the crimping device (22) has at least two press elements (220) which are arranged opposite one another on the cable feed through (100), and
wherein the at least two press elements (220) are driven by a piezo actuator in order to provide a crimping pressure, and
wherein, by means of the piezo actuator, a crimping pressure or a crimping force of a crimping of a press element (220) is also detected.

17. The crimping tool (1) as claimed in claim 13,
wherein the printing device (23) is set up to print a region of the cable (4) adjacent to the electrical conductor (40) crimped with the contact sleeve (5) with information characterizing a crimping of the electrical conductor (40) with the contact sleeve (5),
wherein the crimping tool (1) is networked in terms of signals and data so that the information characterizing the crimping can also be documented with network support.

18. The crimping tool (1) as claimed in claim 14,
wherein the crimping tool (1) has sensors (31, 32) for detecting values characterizing a crimping of the electrical conductor (40), with at least one temperature sensor (32) and at least one force sensor (32), and
wherein for determining a cable length (L) and for positioning a cable end of the cable (4) in the trimming and stripping device (21) at the cable feed through (100), a measuring device (320) is provided adjacent to the friction wheel drive (20) and the trimming and stripping device (21).

19. The crimping tool (1) as claimed in claim 13,
wherein the crimping tool (1) has a camera (31) for hardware and software supported reading of production order parameters of a crimping,
wherein the crimping tool (1) interacts with a cell phone (6) which provides the production order parameters for reading with the camera (31) on its display,
wherein the production order parameters comprise a length (L) and a diameter and a stripping length and a type of cable (4) and a contact type of the contact sleeve (5).

20. The crimping tool (1) as claimed in claim 14,
wherein the crimping tool (1) comprises a housing with a handle (11), at one end of which an elongate head (10) adjoins, and at another end of which a foot region (12) adjoins,
wherein the head (10) accommodates the cable feed through (100), the friction wheel drive (20), the trimming and stripping device (21), the crimping device (22), and the printing device (23), and
wherein the handle (11) accommodates a waste container (24) for collecting cable offcuts and insulation cuttings from the trimming and stripping device (21) and a magazine (25) for feeding contact sleeves (5) to the crimping device (22) and a control unit (3) of the crimping tool (1), and
wherein the foot region (12) accommodates a battery for supplying power to the crimping tool (1).

21. A method (V) for crimping a contact sleeve (5) onto an electrical conductor (40) of a cable (4) using the crimping tool (1) as claimed in claim 13, comprising:
carrying out steps of a method that prepares for the crimping operation (V0);
carrying out steps of a first method (V1) for crimping a first contact sleeve (5) on a first cable end of the cable (4) onto the electrical conductor (40);
carrying out steps of a second method (V2) for crimping a second contact sleeve (5) on a second cable end of the cable (4) onto the electrical conductor (40);
wherein in the method (V0)
production order parameters are determined and detected by the crimping tool (1) and comprise the length (L) and the diameter and the stripping length and the type of cable (4) and the contact type of the contact sleeve (5); and
the crimping tool (1) is set to a first operating state (B1) using the production order parameters;
in the method (V1) and (V2)
the cable (4) with its respective first and second cable ends to be stripped and crimped is first inserted into the crimping tool (1) via the cable inlet opening (101) of the cable feed through (100); and
using the friction wheel drive (20) in the cable feed through (100), the cable end of the cable (4) to be crimped is transported to the trimming and stripping device (21), the crimping device (22) and the printing device (23) and positioned as intended; and
is led out of the crimping tool (1) via the cable outlet opening (102) after each of the methods (V1) and (V2) has been carried out;
wherein the methods (V0), (V1), and (V2) are performed in this order successively.

22. The method (V) as claimed in claim 21, wherein in the method (V1)
the first cable end of the cable (4) is cut by the trimming and stripping device (21) by a predetermined amount; and
the electrical conductor (40) is stripped at the first cable end of the cable (4) by the trimming and stripping device (21); and
the stripped electrical conductor (40) of the first cable end is crimped with a first contact sleeve (5) by the crimping device (22); and
a region of the cable (4) adjacent to the first contact sleeve (5) crimped with the electrical conductor (40) is printed by the printing device (23) with information characterizing the crimping; and
the cable (4) is cut to the length (L) by the trimming and stripping device (21) so that the second cable end of the cable (4) is provided.

23. The method (V) as claimed in claim 21, wherein in the method (V2)
the second cable end of the cable (4) is cut by the trimming and stripping device (21) by a predetermined amount; and
the electrical conductor (40) is stripped at the second cable end of the cable (4) by the trimming and stripping device (21); and
the stripped conductor (40) of the second cable end is crimped with a second contact sleeve (5) by the crimping device (22); and
a region of the cable (4) adjacent to the second contact sleeve (5) crimped with the electrical conductor (40) is printed by the printing device (23) with information characterizing the crimping.

24. The method (V) as claimed in claim 21, wherein the method (V0) comprises the following steps:
in a first step (S01) the production order parameters are determined and compiled using a cell phone (6);
in a second step (S02) the production order parameters determined and compiled by the cell phone (6) are shown on a display of the cell phone (6) and read in by the camera (31) of the crimping tool (1);
in a third step (S03) the crimping tool (1) is brought into the first operating state (B1), taking into account the production order parameters that have been read in;
in a fourth step (S04) it is checked whether a contact sleeve (5) to be crimped is arranged in its intended position in the crimping device (22) and, if necessary, fed to the crimping device (22).
